(19) United States
(12) Patent Application Publication
(10) Pub. No.: US 2011/0217407 A1
(43) Pub. Date: Sep. 8, 2011

(54) MATERIAL SHEET GUIDING SYSTEM FOR A THERMOFORMING MACHINE

(76) Inventor: KEN HAINES, Gladwin, MI (US)

(21) Appl. No.: 12/717,128

(22) Filed: Mar. 3, 2010

(51) Int. Cl. B29C 51/18

(52) U.S. Cl. 425/397

(57) ABSTRACT

A material sheet guiding system of a thermoforming machine comprising: a pair of longitudinal rail members disposed in a spaced parallel relation to one another, and a drive unit. Each of the pair of longitudinal rail members has a first and a second set of wheels disposed longitudinally between a first end portion and a second end portion of the each of the pair of longitudinal rail member along a length thereof. Each wheel of the first set of wheels configures a nip arrangement with a corresponding wheel of the second set of wheels. The drive unit is operatively coupled to the first set of wheels of the each of the pair of longitudinal rail members to rotate the first set of wheels for moving the material sheet from the first end portion to the second end portion through the nip arrangement.

### FIELD OF THE INVENTION

The present invention relates to thermoforming machines, and more particularly, to a material sheet guiding system for a thermoforming machine for guiding a material sheet to an oven chamber of the thermoforming machine.

### BACKGROUND OF THE INVENTION

In a conventional thermoforming machine, a process of indexing of a material sheet to an oven chamber, for producing different size parts from the material sheet, is carried out by a guiding mechanism. Typically, conventional guiding mechanism includes pin chains mounted on rails that capture the sheet material along edges thereof. The pin chains carry the captured material sheet into the oven chamber for producing the different size parts. Usually for producing the different size parts, material sheets of different thicknesses are dragged into the oven chamber by using the pin chains.

The pin chains of the conventional guiding mechanism are usually suitable for indexing the material sheets of small sizes. Specifically, the pin chains used in thermoforming machines utilizing material sheets of large sizes may stretch and drag over an extended usage thereof, thereby requiring replacement of the pin chains. Accordingly, the maintenance cost of the guiding mechanism of such thermoforming machines may be increased.

Further, the pin chains of the conventional thermoforming machines may not have sufficient indexing variation in order to accommodate the material sheets of variable thicknesses and sizes for enabling accurate form and trim of the parts produced from the material sheets. Such insufficient indexing variation may minimize effectiveness of the thermoforming machines.

Accordingly, there exists a need for a guiding mechanism of a thermoforming machine that is capable of improving indexing accuracy to maximize effectiveness of the thermoforming machine. Further, there exists a need for a guiding mechanism that enables substantial reduction in maintenance cost, such as a chain replacement cost of the thermoforming machines.

### SUMMARY OF THE INVENTION

In view of the forgoing disadvantages inherent in the prior-art, the general purpose of the present invention is to provide a material sheet guiding system of a thermoforming machine that is configured to include all advantages of the prior art, and to overcome the drawbacks inherent in the prior art.

An object of the present invention is to provide a material sheet guiding system of a thermoforming machine that is capable of improving indexing accuracy of the thermoforming machine in order to maximize effectiveness thereof

Another object of the present invention is to provide a material sheet guiding system of a thermoforming machine that is capable of reducing maintenance cost, such as maintenance cost associated with pin chains replacement, thereof

To achieve the above objects, in an aspect of the present invention, a material sheet guiding system of a thermoforming machine is provided. The material sheet guiding system of the thermoforming machine is capable of guiding a material sheet. The material sheet guiding system comprises a pair of longitudinal rail members, and a drive unit. The pair of longitudinal rail members are disposed in a spaced parallel relation to one another. Further, each of the pair of longitudinal rail member has a first set of wheels and a second set of wheels disposed longitudinally between a first end portion and a second end portion of the each of the pair of longitudinal rail members along a length thereof. Furthermore, each wheel of the first set of wheels configures a nip arrangement with a corresponding wheel of the second set of wheels. Moreover, the drive unit is operatively coupled to the first set of wheels of the each of the pair of longitudinal rail members. The drive unit rotates the first set of wheels for moving the material sheet from the first end portion to the second end portion through the nip arrangement.

This together with the other aspects of the present invention, along with the various features of novelty that characterized the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a material sheet guiding system of a thermoforming machine, in accordance with an exemplary embodiment of the present invention;

FIG. 2 illustrates a top view of the material sheet guiding system according to the present invention; and

FIG. 3 illustrates a front view of the material sheet guiding system according to the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The term “first,” “second,” and the like, herein do not denote any order, elevation or importance, but rather are used to distinguish placement of one element over another.

The terms “a” and “an” herein do not denote a limitation of quantity, but rather denote the presence of at least one of the referenced item.

The present invention provides a material sheet guiding system of a thermoforming machine. The material sheet guiding system of the thermoforming machine is capable of guiding a material sheet to an oven chamber of the thermoforming machine. The material sheet guiding system includes a nip-wheel arrangement that maximizes thermoforming effectiveness by improving indexing accuracy and improving precision methods for enabling accurate form and trim of parts produced from the material sheet.

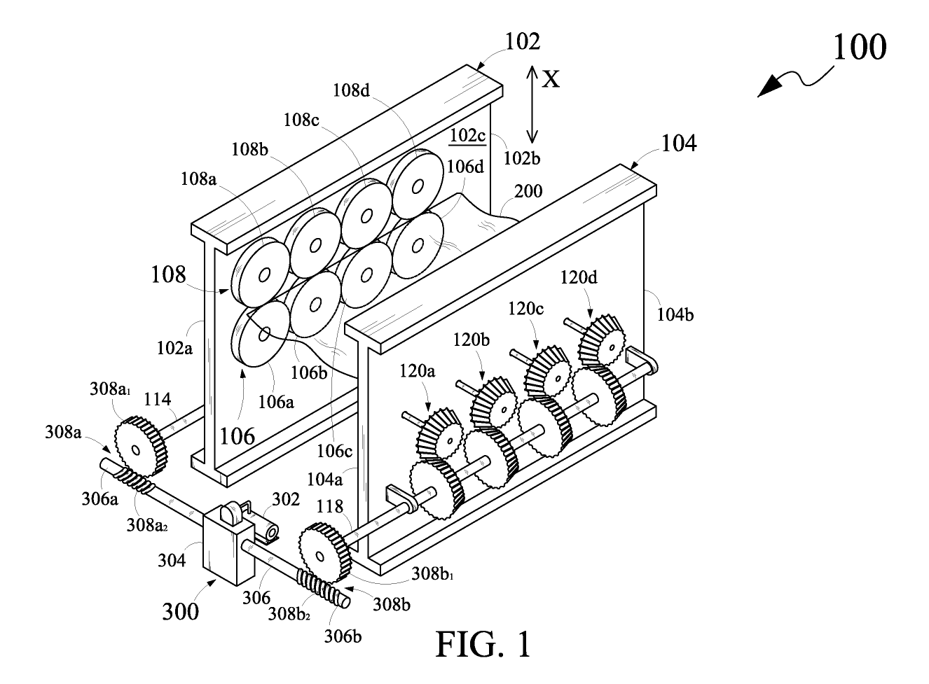

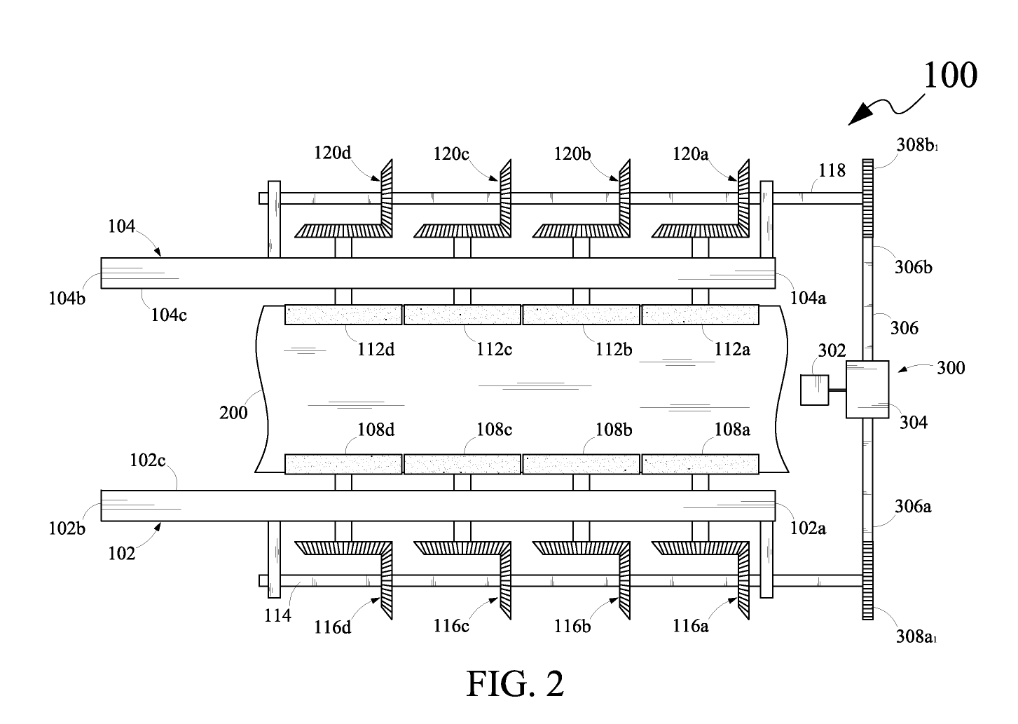

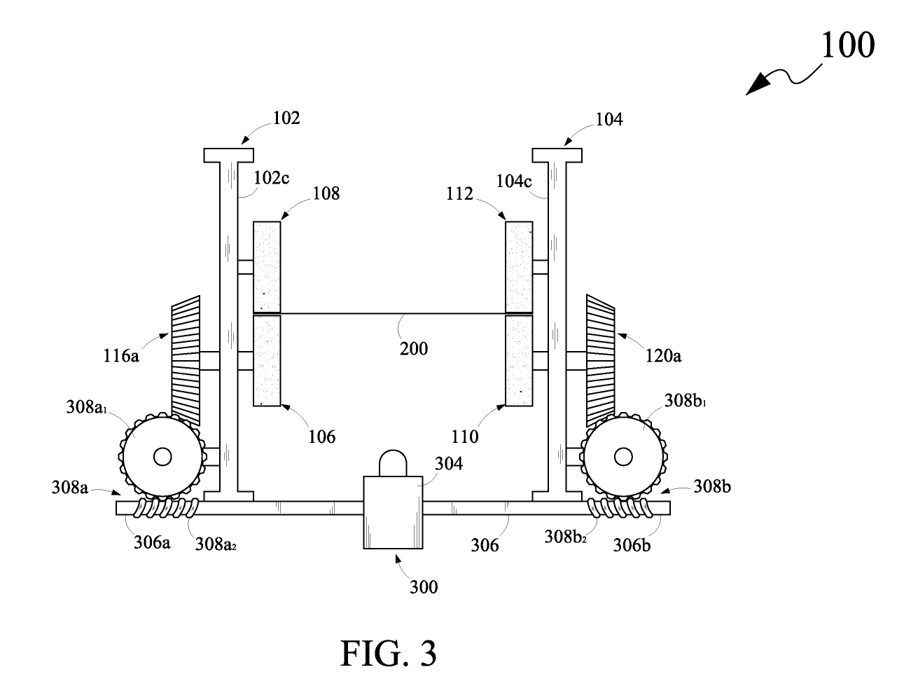

Referring now to FIGS. 1 to 3, several views of a material sheet guiding system 100 of a thermoforming machine (not shown) are illustrated, according to an exemplary embodiment of the present invention. More particularly, FIG. 1 illustrates a perspective view of the material sheet guiding system 100 of the thermoforming machine. Further, FIG. 2 illustrates a top view of the material sheet guiding system 100. Furthermore, FIG. 3 illustrates a front view of the material sheet guiding system 100.

The material sheet guiding system 100 (hereinafter referred to as “guiding system 100”) of the present invention is capable of guiding a material sheet 200 to an oven chamber (not shown) of the thermoforming machine. The guiding system 100 includes a pair of longitudinal rail members 102 and 104 (hereinafter referred to as “rail member 102,” and “rail member 104”), and a drive unit 300.

The rail member 102 and the rail member 104 are disposed vertically in a spaced parallel relation to one another, as shown in FIG. 1, on a surface, such as a floor of a work area or a floor of the thermoforming machine. However, it will be evident to a person skilled in the art to dispose the rail member 102 and the rail member 104 may be disposed in other orientations also, such as in a slanted spaced parallel relation to one another. Further, each of the rail members, that is, the rail member 102 and the rail member 104, includes a first set of wheels and a second set of wheels. More particularly, as shown in FIG. 1, the rail member 102 includes a first set of wheels 106 and a second set of wheels 108 disposed longitudinally between a first end portion 102a and a second end portion 102b along a length of the rail member 102. Further, the first set of wheels 106 and the second set of wheels 108 are disposed on respective inner surfaces of the corresponding rail members. For example, as shown in FIG. 1, the first set of wheels 106 and the second set of wheels 108 are disposed on an inner surface 102c of the rail member 102.

According to one embodiment of the present invention, wheels 106a-d of the first set of wheels 106, and wheels 108a-d of the second set of wheels 108 are rotatably disposed between the first end portion 102a and the second end portion 102b. Each wheel of the wheels 106a-d configures a nip arrangement with a corresponding wheel of the second set of wheels 108. Specifically, the wheel 106a configures a nip arrangement with the wheel 108a. Similarly, the wheels 106b, 106c, and 106d, respectively, configure nip arrangements with the corresponding wheels 108b, 108c, and 108d.

Similar to the rail member 102, the rail member 104 includes a first set of wheels 110 and a second set of wheels 112 (as shown in FIG. 3) that are disposed longitudinally between a first end portion 104a and a second end portion 104b (as shown in FIGS. 1 and 2) along a length of the rail member 104. Further, similar to the first set of the wheels 106 and the second set of wheels 108, the first set of the wheels 110 and the second set of wheels 112 are rotatably disposed on an inner surface 104c (as shown in FIGS. 2 and 3) between the first end portion 104a and the second end portion 104b. Furthermore, similar to the nip arrangements configured between the wheels 106a-d of the first set of wheels 106 with the corresponding wheels of the second set of wheels 108 of the rail member 102, nip arrangements between each wheel (not shown) of the first set of wheels 110 with corresponding wheels 112a-d (as shown in FIG. 2) of the second set of wheels 112 of the rail member 104 are configured.

The nip arrangements configured between the first set of wheels 106 and the second set of wheels 108 of the rail member 102, and between the first set of wheels 110 and the second set of wheels 112 of the rail member 104 are utilized for moving the material sheet 200 from the first end portions 102a and 104a of the rail members 102 and 104, to the second end portions 102b and 104b of the rail member 102 and 104. Specifically, the material sheet 200 is moved through the nip arrangements configured between the first set of wheels 106 and the second set of wheels 108 of the rail member 102, and between the first set of wheels 110 and the second set of wheels 112 of the rail member 104.

Number of the wheels of the first sets of wheels 106 and 110, and number of the wheels of the second sets of wheels 108 and 112 as shown in FIGS. 1 to 3, are for the purpose of representation and description only, and may not considered to be limiting the scope of the present invention. Further, it will be evident to a person skilled in the art to increase or decrease the number of the wheels of the first sets of wheels 106 and 110, and the number of the wheels of the second sets of wheels 108 and 112 of the guiding system 100, as per requirement.

Further referring to FIGS. 1 and 2, the wheels 106a-d of the first set of wheels 106, and wheels of the first set of wheels 110 are rotatable about respective axes thereof. More particularly, the wheels 106a-d of the first set of wheels 106 are meshed with a rotatable shaft member 114 by means of gear arrangements. Specifically, the wheels 106a-d are meshed with the rotatable shaft member 114 by respective gear arrangements 116a-d (as shown in FIGS. 2 and 3). Similarly, the wheels of the first set of wheels 110 are meshed with a rotatable shaft member 118 by a means of gear arrangements 120a-d (as shown in FIGS. 1 and 2). The wheels 106a-d of the first set of wheels 106, and the wheels of the first set of wheels 110 are capable of being rotated at respective axes thereof, on rotation of the respective rotatable shaft members 114 and 118. In one exemplary embodiment, the gear arrangement includes a bevel gear arrangement for transferring the motion of the rotatable shaft members 114, 118 to the respective sets of wheels.

Furthermore, each wheel of the second sets of wheels 108 and 112 are biasingly engaged to corresponding rail members 102 and 104. More particularly, the wheels 108a-d (as shown in FIGS. 1 and 2) of the second set of wheels 108 are biasingly engaged to the rail member 102 such that the wheels 108a-d are adapted to move in a linear direction ‘X’ (as shown in FIG. 1), perpendicular to respective axes thereof Similarly, the wheels 112a-d of the second set of wheels 112 are biasingly engaged to the rail member 104 for a linear direction movement, perpendicular to respective axes thereof. According to one embodiment of the present invention, biasing engagements between the second sets of wheels 108 and 112 with respective rail members 102 and 104 are provided by means of spring arrangements (not shown). However, it will be evident to a person skilled in the art to provide the biasing engagements by any other suitable means. Upon moving the material sheet 200 through the nip arrangements, the biasing engagements facilitates in adjusting nip thicknesses of the respective nip arrangements, according to a thickness of the material sheet 200, for moving different material sheets, such as the material sheet 200, having different thicknesses through the nip arrangements.

As shown in FIGS. 1 to 3, the drive unit 300 is operatively coupled to the first sets of wheels 106 and 110 through the respective rotatable shaft members 114 and 118 to rotate the first sets of wheels 106 and 110 for moving the material sheet 200 from the first end portions 102a and 104a to the second end portions 102b and 104b by utilizing the nip arrangements.

More particularly, the drive unit 300 includes a drive motor 302, a gear box arrangement 304, and a shaft member 306. The gear box arrangement 304 is operatively coupled to the drive motor 302. According to one embodiment of the present invention, the drive motor 302 is a servo motor. However, it will be evident to a person skilled in the art to use various other types of the drive motors known in the art. Further, the shaft member 306 is rotatably coupled to the gear box arrangement 304. The shaft member 306 is rotatable about an axis thereof, when the drive motor 302 is electrically driven.

A proximal end portion 306a and a distal end portion 306b of the shaft member 306 are operatively coupled to the first sets of wheels 106 and 110 for rotating the first sets of wheels 106 and 110. More specifically, the rotatable shaft members 114 and 118 are, respectively, rotatably coupled to the proximal end portion 306a and the distal end portion 306b of the shaft member 306 for establishing an operative coupling between the rotatable shaft members 114 and 118, and the shaft member 306. According to one embodiment of the present invention, the operative coupling between the rotatable shaft members 114 and 118 and the shaft member 306 is established by sprocket arrangements 308a and 308b configured, respectively, at the proximal end portion 306a and the distal end portion 306b of the shaft member 306. However, it will be evident to a person skilled in the art that operative coupling between the rotatable shaft members 114 and 118 and the shaft member 306 may be established by means of gear arrangements, chain arrangements or by other means known in the art.

According to the present embodiment, the sprocket arrangements 308a and 308b, respectively, include a sprocket wheel 308a₁ disposed at an end portion of the rotatable shaft member 114, and a sprocket wheel 308b₁ disposed at an end portion of the rotatable shaft member 118. Teeth of sprocket wheels 308a₁ and 308b₁, respectively, engage with respective complementary threads 308a₂ and 308b₂ configured on the proximal end portion 306a and the distal end portion 306b of the shaft member 306. The engagement therebetween is in such a manner that a rotation of the shaft member 306 enables rotation of the sprocket wheels 308a₁ and 308b₁, thereby rotating the rotatable shaft members 114 and 118.

In operation, the guiding system 100 is capable of guiding the material sheet 200 to the oven chamber of the thermoforming machine. On electrically coupling the motor unit 302, the motor unit 302 rotates the shaft member 306 about the axis thereof. Further, the rotatable shaft members 114 and 118 that are, respectively, rotatably coupled to the proximal end portion 306a and the distal end portion 306b of the shaft member 306, start rotating about respective axes thereof, thereby rotating the first sets of wheels 106 and 110. Thereafter, the material sheet 200 is provided in the nip arrangements configured between the first set of wheels 106 and the second set of wheels 108, and between the first set of wheels 110 and the second set of wheels 112. The second sets of wheels 108 and 112 are capable of being adjusted in a lateral direction from respective axes thereof to adjust the nip thicknesses of the respective nip arrangements based on the thickness of the material sheet 200. The nip thicknesses are adjusted to accommodate variable thicknesses of the material sheet 200 for a movement thereof from the first end portions 102a and 104a to the second end portions 102b and 104b of the rail members 102 and 104, and further to the oven chamber of the thermoforming machine.

A material sheet guiding system, such as the guiding system 100 of the present invention offers the following advantages. The material sheet guiding system precludes use of pin chain arrangement and includes nip arrangements that are capable of maximizing thermoforming effectiveness by improving indexing accuracy. The material guiding system is equipped with a servo motor for improving the indexing accuracy. Further, the nip arrangement increases production and reduce strain from material sheets of large and small sizes. Furthermore, due to utilization of the nip arrangement instead of the pin chain arrangement, maintenance cost of the thermoforming machine is, in turn, reduced.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A material sheet guiding system of a thermoforming machine for guiding a material sheet, the material sheet guiding system comprising:
a pair of longitudinal rail members disposed in a spaced parallel relation to one another, each of the pair of longitudinal rail members having a first set of wheels and a second set of wheels disposed longitudinally between a first end portion and a second end portion of the each of the pair of longitudinal rail members along a length thereof, wherein each wheel of the first set of wheels configures a nip arrangement with a corresponding wheel of the second set of wheels; and
a drive unit operatively coupled to the first set of wheels of the each of the pair of longitudinal rail members to rotate the first set of wheels for moving the material sheet from the first end portion to the second end portion through the nip arrangement.

2. The material sheet guiding system according to claim 1, wherein the drive unit comprises:
a drive motor;
a gear box arrangement operatively coupled to the drive motor; and
a shaft member rotatably coupled to the gear box arrangement, wherein a proximal end portion and a distal end portion of the shaft member are operatively coupled to the first set of wheels of the each of the pair of longitudinal rail members to rotate the first set of wheels.

3. The material sheet guiding system according to claim 1, wherein each wheel of the second set of wheels is biasingly engaged to a corresponding longitudinal rail member for enabling adjustment of a nip thickness of the nip arrangement for enabling movement of material sheets of variable thicknesses therethrough.

4. The material sheet guiding system according to claim 1, where the first set of wheels and the second set of wheels of each rail member are disposed on the respective inner surfaces of the corresponding rail members.

5. The material sheet guiding system according to claim 1, where the first set of wheels and the second set of wheels of each rail member include an equal number of wheels in each set.

6. The material sheet guiding system according to claim 5, where first set of wheels and the second set of wheels of each rail member include at least four wheels in each set.

7. The material sheet guiding system according to claim 1, where the first set of wheels are meshed with a rotatable shaft member by means of gear arrangements, where the first set of wheels are capable of being rotated at respective axes thereof, on rotation of the rotatable shaft member.

8. The material sheet guiding system according to claim 7, where the gear arrangements include bevel gears for transferring the motion of the rotatable shaft member to the first set of wheels.

9. The material sheet guiding system according to claim 1, where upon moving the material sheet through the nip arrangement biasing engagements facilitate in adjusting nip thicknesses of the respective nip arrangements, according to a thickness of the material sheet.
